(19) United States
(12) Patent Application Publication
(10) Pub. No.: US 2014/0008004 A1
(43) Pub. Date: Jan. 9, 2014

(54) METHOD AND COUPLER FOR JOINING POLYMERIC TUBULAR OBJECTS

(71) Applicants: Joel A. Dyksterhouse, Cross Village, MI (US); Edward J. Gordon, Grand Blanc, MI (US)

(72) Inventors: Joel A. Dyksterhouse, Cross Village, MI (US); Edward J. Gordon, Grand Blanc, MI (US)

(73) Assignee: THERCOM HOLDINGS, LLC, Bloomfield Hills, MI (US)

(21) Appl. No.: 13/542,001

(22) Filed: Jul. 5, 2012

(51) Int. Cl. F16L 47/02; B32B 41/00; B32B 37/06

(52) U.S. Cl. 156/64; 285/294.1; 156/83

(57) ABSTRACT

The specification discloses a method and a coupler for joining polymeric tubular objects, such as pipe. The coupler includes (a) a rigid, electromagnetically inductive carrier, (b) a temperature-responsive expandable material on the carrier, and (c) a polymeric material on the expandable material. The method includes the steps of (a) inserting the coupler into the ends of two adjacent polymeric tubular objects, (b) creating an electromagnetic field about the coupler causing the carrier to heat, in turn causing the expandable material to expand and force the polymeric material against the tubular objects, and further in turn causing the polymeric material to melt, soften, or liquefy, and (c) terminating the electromagnetic field allowing the polymeric material to cure or solidify to bond to the tubular objects.

### BACKGROUND OF THE INVENTION

The present invention relates to polymeric pipe, and more specifically to methods and couplers for joining such pipe.

“Polymeric” as used in this application includes all polymeric materials and composites including polymeric materials. Without limitation, “polymeric” includes thermoset, thermoplastics, and composites thereof.

Polymeric pipe is well known and widely used in a variety of applications. For example, such pipe is playing an ever increasing role in the transportation of petroleum products, gases, slurries, and liquids. Techniques for connecting such pipe end to end, or connecting such pipe to another differing object, include butt fusing, socket fusing, electro fusing, bead-and-crevice-free fusing (BCF), infrared (IR) fusing, and metal couplings. Examples of fusing systems include those sold by Georg Fisher Piping Systems of Schaffhausen, Switzerland. However, these methods and couplings are difficult to use, inconsistently reliable, and relatively expensive.

Consequently, a continuing need exists for methods and couplings that are simpler, more reliable, and less expensive.

### SUMMARY OF THE INVENTION

The afore-mentioned issues are addressed by the present invention, which provides a simple, reliable, and relatively inexpensive method and coupling for connecting polymeric tubular objects such as pipe.

More specifically, the coupling of the present invention includes a carrier fabricated of a heatable material, a temperature-responsive expandable material over the carrier, and a temperature-responsive polymeric material over the expandable material.

The method of the present invention uses the novel coupling. The method includes the steps of 1) inserting the coupling into the adjacent ends of two tubular polymeric objects, such as pipe, and 2) heating the heatable carrier which heats the expandable material and the polymeric material. The heated expandable material forces the heated molten polymeric material outwardly against the tubular objects. The polymeric material bonds to the polymeric tubular objects.

The coupling and the method are simple, efficient, reliable, and relatively inexpensive.

These and other advantages and features of the invention will be more fully understood and appreciated by reference to the drawings and the description of the current embodiment.

### DESCRIPTION OF THE DRAWINGS

FIG. 1 is a perspective exploded view of the coupler and two pipe sections.

FIG. 2 is a side view of the coupler inserted into one of the pipe sections.

FIG. 3 is a longitudinal sectional view of the coupler.

FIG. 4 is a transverse sectional view of the coupler and one of the pipe sections. The upper left quadrant shows the coupler alone. The lower left quadrant shows the unscarfed pipe section alone. The right half shows the coupler within the scarfed pipe section.

FIG. 5 is an enlarged transverse sectional view of the coupler and the pipe section.

FIG. 6 is a side view of the coupler within one pipe section and adjacent the other pipe section.

FIG. 7 is a longitudinal sectional view of the coupler within the two pipe sections.

FIG. 8 is side view partially in section showing an induction coil about the coupler.

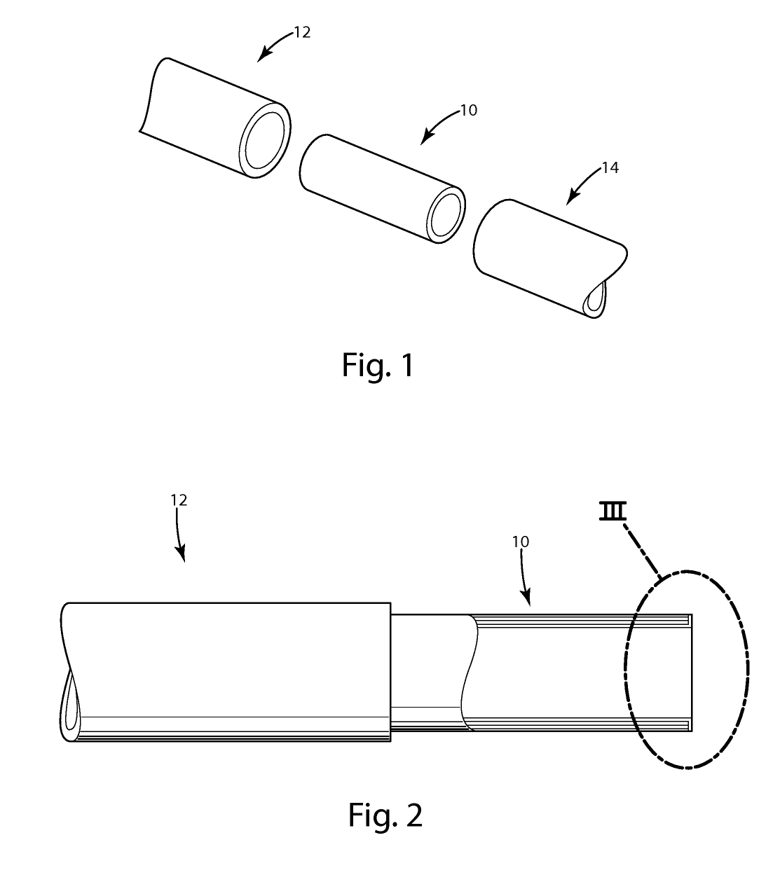

### DESCRIPTION OF THE CURRENT EMBODIMENT

### I. Coupler

A coupler constructed in accordance with a current embodiment of the invention is illustrated in the drawings and generally designated 10. The coupler may be used to join two polymeric tubular objects such as pipe sections 12 and 14. The pipes are cylindrical, but may be of any tubular shape. The coupler includes a carrier 16, an expansion layer 18, a structural layer 20, and a sealing layer 22.

The carrier 16 functions both as a structural component and as an inductive or conductive layer. The carrier 16 of the current embodiment is fabricated of an electromagnetically inductive or conductive material. For example, the carrier 16 may be metal (e.g. steel, stainless steel, or aluminum) or graphite. Therefore, electromagnetic currents may be induced in the carrier, or an electrical current can be applied to the carrier, to heat the carrier as will be described below. Alternatively, the carrier may be any other heatable material.

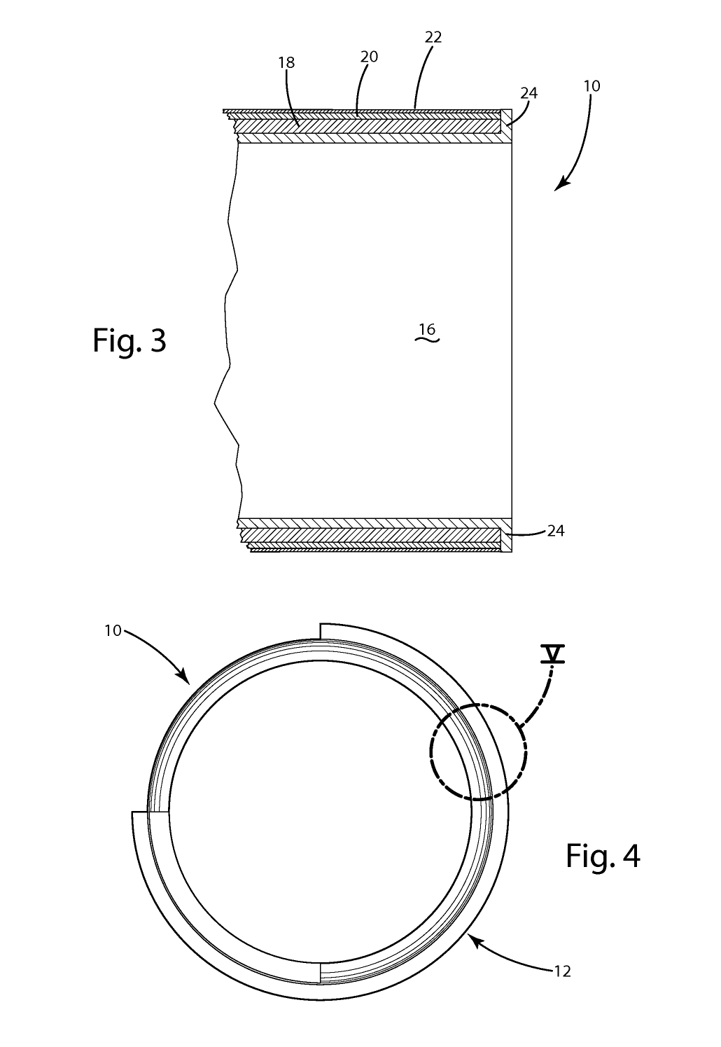

The carrier 16 has a transverse cross section or shape corresponding to the cross section of the objects to be joined. The current carrier is cylindrical and tubular, having an inside dimension (ID) corresponding to the objects to be joined and a length that is suitable for providing sufficient joint surface area. In the current embodiment, the carrier 16 is approximately 0.125 inch thick steel, is approximately 12 inches long, and has an ID of approximately 4 inches. The carrier includes first and second shoulders 24 (see FIG. 3) at the opposite ends of the carrier.

The expansion layer 18 is on or over the carrier 16. The expansion layer may be any temperature-responsive material that expands in response to a temperature change, typically heating. In the current embodiment, the expansion layer 18 may be wrapped or coated onto the carrier 16. The expansion layer 18 may be for example silicone or silicone rubber in view of its relatively high degree of expansion in response to heating. For example, silicone may expand by a factor of seven times its original volume in response to heat. In the current embodiment, the expansion layer is approximately 0.075 inch thick.

The structural layer 20 may be a polymeric material that provides strength. Consequently, the structural layer 20, when molten, will fuse or bond to the polymeric pipe sections 12 and 14 in response to heat and pressure. In the current embodiment, the structural layer is approximately 0.120 inch thick high-density polyethylene (HDPE/E-glass fiber reinforcement) 0/90.

The sealing layer 22 may be included as an additional polymeric material that further provides or enhances a bond and or a seal between the structural layer 20 and the pipe sections 12 and 14. In the current embodiment, the sealing layer is approximately 0.010 inch thick HDPE film.

In the current embodiment, the activation temperature of the expansion layer 18 is lower than the activation temperatures of the structural layer 20 and the sealing layer 22. Consequently, layer 18 expands before layers 20 and 22 melt as described below.

In addition to the described layers, the coupler 10 may have additional layers over or under the described layers, or interleaved with the described layers.

### II. Method

The current embodiment of the method utilizes the current embodiment of the coupler 10.

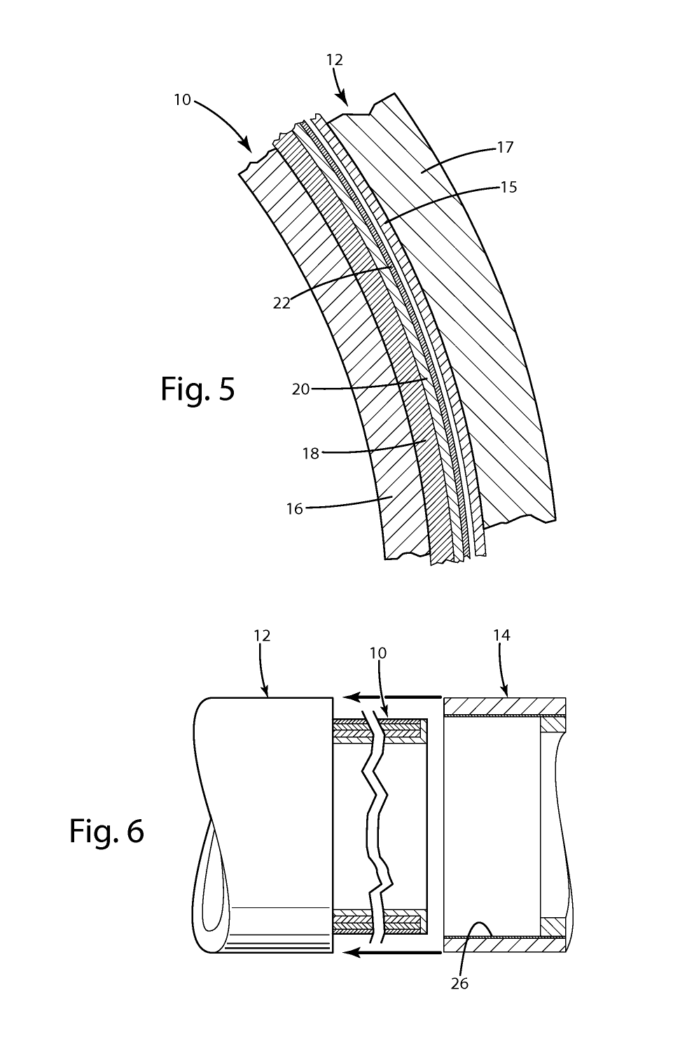

In the current embodiment, the pipe sections 12 and 14 are high-pressure (e.g. above 5,000 psi) HDPE thermoplastic composite pipes (ANSI 600) having a 4″ ID. As perhaps best illustrated in FIGS. 4-5, each pipe section includes a pure HDPE liner 13, an ethylene vinyl alcohol (EVOH) vapor barrier (not illustrated), an HDPE/E-Glass composite layer 17, and a pure HDPE outer protective layer 19. Alternatively, the pipe sections may be designed for different pressures, may include different materials, and may be of different dimensions.

The two ends of the pipe sections 12 and 14 to be joined may be prepared to be relatively square, clean, and of uniform dimensions.

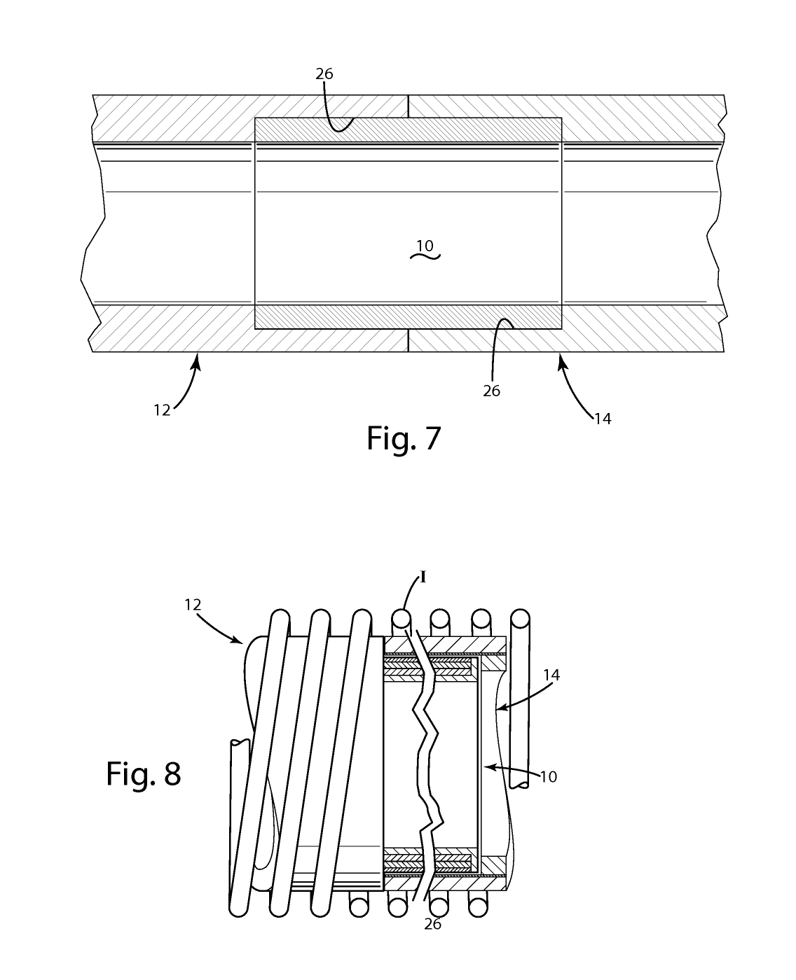

An interior portion of the inside wall of the pipe sections 12 and 14 may be removed to create a scarf 26 (see FIGS. 6-7) to provide a consistent ID throughout the completed joint including the coupler 10 and the pipe sections. In the current embodiment, approximately 12 inches are scarfed from each of the pipe sections 12 and 14. As an alternative to scarfing, the pipe sections 12 or 14 (e.g. in stick pipe form) or other tubular objects may be formed or fabricated in such a way that the scarfs are created during manufacture of the pipe.

The coupler 10 is inserted into both pipe sections 12 and 14. If scarfs 26 have been created, then the coupler 10 is positioned wholly or partially in the scarfs. The carrier shoulders 24 (see FIG. 3) are no larger in outside diameter (OD) than the scarfs 26. Preferably the coupler 10 is positioned so that approximately one-half of the coupler is in each pipe section 12 and 14. The pipe sections may be pushed tightly together over the coupler.

In the current embodiment, the carrier is remotely heated following insertion using induction heating. Specifically, an electromagnetic field is created around the coupler 10 to induce electromagnetic currents in the carrier 16. In the current embodiment, the pipe sections 12 and 14 are overwrapped with an induction coil 28 (see FIG. 8) so that the full length of the coupler 10 inside the pipe section is covered. An electrical current is then passed through the induction coil 28 so that the carrier 10 is heated to a temperature sufficient to melt, soften, or liquefy the polymeric structural layer 20 and the polymeric sealing layer 22.

An example of an induction heating system suitable for use in the current method is the system sold by Miller Electric Mfg. Co. of Appleton, Wis. as model ProHeat™ 35, which includes a control system enabling the temperature to be controlled with a high degree of precision. Other suitable inductive heating systems will be recognized by those skilled in the art.

As a first heating alternative, microwave radiation or any other source of energy may be used instead of induction to achieve similar results as long as the carrier 16 accepts microwave radiation or the other source of energy.

As a second heating alternative, electrically conductive wires (not shown) may be connected to the carrier 16 to conduct electrical current through the carrier.

Other techniques for heating the carrier 16, either with our without direct contact, will be recognized by those skilled in the art.

Optionally, one or more temperature-sensing devices such as thermocouples (not shown) may be used to monitor the actual temperature at one more locations. For example, a thermocouple may be used to monitor the temperature of the carrier 16, and another thermocouple may be used to monitor the temperature of the pipe sections 12 and 14. If used to measure the temperature of the carrier, the thermocouple may be inserted through the gap between the pipe sections 12 and 14 to engage the carrier 16. Other temperature-measuring devices, both contact and non-contact, will be recognized by those skilled in the art. When used, the thermocouple can be operatively connected to the heating system to provide closed-loop control to achieve a desired temperature profile for the heating process.

The heating of the carrier 16 causes the heating of the expansion layer 18, the structural layer 20, and the sealing layer 22 in that order. As the polymeric layers 20 and 22 are heated, they melt. The fact that the silicone layer 18 is heated and expands before the polymeric layers 20 and 22 are heated and expand is advantageous because the polymeric layers are pressurized before they melt. As the expansion layer is heated, it expands to apply pressure or force to the layers 20 and 22 to enhance the bond between the molten layers and the pipe sections. The heated coupler 10 causes the silicone rubber of the expansion layer 18 to expand pushing out against the molten structural layer 20 and the molten sealing layer 22. The molten sealing layer 22 is pushed outward filling gaps around the carrier module and the gap between the two pipe sections. As the sealing layer 22 is moved, the molten structural layer 20 is forced against the inner wall of the pipe sections 12 and 14.

The sealing layer 22 may have a color different from the pipe sections 12 and 14 to provide a visual confirmation of proper melting and pressure when the sealing layer 22 is visible at the gap between the pipe sections 12 and 14 when the sealing layer is forced into and through the gap.

A predetermined or controlled amount of current is maintained for a predetermined or controlled amount of time in order (a) to melt the polymeric layers 20 and 22 and (b) to produce the desired pressure of the layers against the pipe sections 12 and 14. The current is then terminated, and the carrier 16 acts as a heat sink causing the polymer of the sealing layer 22 to solidify first, the polymer of the structural layer 20 to solidify second, and the expansion layer 18 to shrink third.

As an optional step, the joint may be cooled following the heating process. The identified ProHeat™ 35 inductive heating system may be used for such cooling. Indeed, the cooling can be quite dramatic, resulting in what might be characterized at “flash cooling.” Other systems and methods for cooling will be recognized by those skilled in the art.

Following solidification (in the case of thermoplastics), the pipe section 12 and 14 are joined and sealed. It is believed that the resulting joint is stronger in burst strength and in tensile strength than the pipe sections 12 and 14.

If the pipe sections or other cylindrical objects are fabricated of thermoset polymer instead of thermoplastic polymer, everything remains essentially the same except that the structural layer and the sealing layer are thermosetting in nature. Time at temperature and pressure is held until the thermoset layers are cured.

An advantage of a metallic carrier 16 is that the coupler 10 may be located relatively easily using metal detectors. This facilitates the location of a joint after the joined pipe sections 12 and 14 have been buried or otherwise located out of sight.

The above description is that of the current embodiment of the invention. Various alterations and changes may be made without departing from the spirit and broader aspects of the invention as defined in the claims. It is again noted that “polymeric” as used in this application includes all polymeric materials and composites including polymeric materials.

1. A method of joining polymeric tubular objects comprising:
providing first and second polymeric tubular objects;
providing a coupler including a rigid carrier, an expandable material outside the carrier that expands in response to a first temperature change, and a polymeric material outside the expandable material that melts, softens, or liquefies in response to a second temperature change;
inserting the coupler into the first and second objects, the coupler being closely received within the first and second objects;
heating the coupler causing the expandable material to expand and causing the polymeric material to melt, soften, or liquefy, whereby the polymeric material is forced against the first and second objects; and
reducing the heating allowing the polymeric material to cure or solidify, whereby the polymeric material bonds to the first and second objects.

2. A method as defined in claim 1 wherein the heating step comprises noncontact heating.

3. A method as defined in claim 2 wherein:
the carrier comprises an electromagnetically conductive material; and
the heating step includes generating an electromagnetic field about the coupler.

4. A method as defined in claim 1 wherein the heating step includes electrically resistive heating.

5. A method as defined in claim 4 wherein:
the carrier comprises an electrically resistive material; and
the heating step includes conducting electrical current through the carrier.

6. A method as defined in claim 1 wherein the first temperature change is lower than the second temperature change, whereby the expandable material expands before the polymeric material melts, softens, or liquefies.

7. A method as defined in claim 1 further comprising:
monitoring the temperature of at least one location on the coupler and the objects; and
controlling the heating step at least partially in response to the monitored temperature.

8. A method as defined in claim 1 wherein the polymeric material includes a strength layer and a sealing layer.

9. A method as defined in claim 1:
further comprising scarfing at least one of the first and second objects before the inserting step; and
wherein the inserting step includes inserting the coupler into the at least one scarf.

10. A method as defined in claim 1 wherein the expandable material comprises silicone.

11. A method as defined in claim 1 wherein the first and second objects and the coupler are all cylindrical.

12. A method as defined in claim 7 wherein the first and second objects are pipe sections.

13. A method of joining polymeric cylindrical tubular objects comprising:
providing first and second polymeric cylindrical objects;
providing a cylindrical coupler including a rigid electromagnetically conductive cylindrical carrier, a temperature-responsive expandable material over the carrier, and a polymeric material over the expandable material;
inserting the coupler into both of the first and second objects;
creating an electromagnetic field around the coupler, including a current in the carrier, and causing the carrier to increase in temperature, in turn causing the expandable material and the polymeric material to increase in temperature, in turn causing the expandable material to expand and force the polymeric material into engagement with the objects, and further in turn causing the polymeric material to melt, soften, or liquefy; and
reducing the electromagnetic field allowing the polymeric material to cure or solidify bonding the polymeric material to the objects.

14. A method as defined in claim 13 wherein the expandable material expands at a first temperature below a second temperature at which the polymeric material melts, softens, or liquefies.

15. A method as defined in claim 13 further comprising:
monitoring the temperature of at least one location on the coupler and the objects; and
controlling the heating step at least partially in response to the monitored temperature.

16. A method as defined in claim 13 wherein the polymeric material includes a strength layer and a sealing layer.

17. A method as defined in claim 13:
further comprising scarfing the objects before the inserting step; and
wherein the inserting step includes inserting the coupler into the scarfs.

18. A method as defined in claim 13 wherein the expandable material comprises silicone.

19. A method as defined in claim 13 wherein the first and second objects are pipe sections.

20-34. (canceled)
